(19) United States
(12) Patent Application Publication
(10) Pub. No.: US 2022/0289601 A1
(43) Pub. Date: Sep. 15, 2022

(54) SYSTEM FOR IMPROVING AND DISTRIBUTING WATER

(71) Applicant: WATERDIAM GROUP LLC, Miami, FL (US)

(72) Inventors: Anthony Ginter, Miami, FL (US); Laurent Pupunat, Delemont (FR)

(21) Appl. No.: 17/601,079

(22) PCT Filed: Apr. 3, 2020
(86) PCT No.: PCT/EP2020/059587

§ 371 Date: May 16, 2022

(30) Foreign Application Priority Data
Apr. 3, 2019 (FR) 1903538

(51) Int. Cl. C02F 1/461; C02F 1/28; C02F 1/00

(52) U.S. Cl. CPC C02F 1/46104; C02F 1/46109; C02F 1/283; C02F 1/001; C02F 2201/4612; C02F 2201/4614; C02F 2301/043; C02F 2001/46138

(57) ABSTRACT

The present invention concerns a water distribution and treatment system (1) comprising, in a housing (2), a hydraulic circuit comprising a connection inlet (31) to a water supply source and a connection outlet (32) to a water distribution device, the connection inlet and outlet being connected together via a solenoid valve (7) electrically connected to an electrical supply and control device (6), characterised in that it comprises a water electrolysis module (5) comprising at least one electrode, the electrolysis module being electrically connected to the supply and control device (6) and hydraulically connected to the connection inlet and outlet (31, 32).

The invention relates to a system for improving the properties of the water and for distributing water, in particular within individual homes, industrial buildings, animal production units or public fountains, intended to be installed on a running water distribution network (and/or borehole with or without filtration and pre-treatment system installed).

Although the access to running water is not yet a reality for all populations worldwide, it has developed strongly during the 20th century and this beginning of the 21st century on all continents, in particular in the urban areas, providing a significant improvement in the sanitary conditions of people who have access to it, in particular for their health, both through improved hygiene and nutrition.

In addition to the problems of wastage arising from direct and almost free access to this limited but essential resource that is water, which give rise to fears for the future, the quality of the running water available through the public distribution networks is often uneven, to the point that in some places it is unfit for consumption, or at least in limited quantities. It is common for health personnel to recommend a spring or mineral water for oral consumption rather than the “tap” water, in particular but not exclusively because of the chemical additives, heavy metals and other contaminants that may be present despite the central purification and treatment systems and techniques used to ensure that the water is safe for consumption, in accordance with the current standards.

Various systems for the treatment, filtration or enrichment of running water for private or industrial use have been proposed for decades. These include salt-based water softeners systems, reverse osmosis systems and in-line filtration installations, comprising for example activated carbon filters. These systems allow in particular to adjust the pH of the drinking water to make it more neutral or to remove certain pollutants. However, they are generally bulky and costly to install and maintain, in particular due to the consumable character of the “active” products they use.

The decontaminating properties of the electrochemical methods of water electrolysis have also been known for a long time. Many electrolysis systems on the market use a diaphragm or a membrane to separate the acidic, oxidizing anode water from the alkaline, reducing cathode water. Other electrolysis systems require the addition of reactive salts for the electrodes employed to function properly and generate oxidants, usually chlorine. Some electrolysis systems focus on the production of oxidants, and comprise, for example, a mixing chamber at the outlet of the electrolysis module, to distribute the generated oxidants evenly in the water. This destroys or mineralizes the organic substances in the water. The ozone concentration is then measured at the outlet of the mixing chamber. To produce even more ozone, some electrolysis systems use a solid electrolyte between the electrodes, which artificially increases the conductance between the electrodes. In all these systems where the objective is to generate oxidants and depollute the water, the current load applied must be high, in the order of 0.5 to 10 Ah/L.

The electrolysis of the water described here has particularly interesting properties for a universal treatment of “running” drinking water because, unlike other treatment methods, its performance does not consist of purifying the water by acting on the majority of contaminants contained therein, or modifying its pH, but rather its intrinsic properties, in particular its oxidizing-reducing character. It is not necessary to have a high current density because the electrolysis according to the invention does not aim to produce ozone, nor to disinfect or depollute the water. The mode of action of the electrolyzed water according to the invention is at the level of the molecular structure of the water molecule, and not at the level of what the water may or may not contain.

These advantageous properties have already been exploited, for example, for the treatment of the water in spas and swimming pools, in order to reduce the use of chemical decontaminants, in particular of the chlorinated or bromide-based type. However, the implementation of the electrolysis requires substantial and bulky installations, preferably in continuous operation together with the water filtration and therefore with a substantial implementation cost.

There is therefore a need to make the important advantages of the electrolysis methods of the water available to the greatest number of people for all everyday uses, whether for oral, hygiene or other purposes.

It is therefore an object of the invention to provide a system for distributing and improving the water by electrolysis which allow an electrolyzed running water to be provided at any time, on demand, for personal consumption and any use.

Another purpose of the invention is to provide a water distribution and treatment system by electrolysis that is simple to implement, maintain and operate at a moderate cost to the user.

Another aim of the invention is to provide a system for distributing and improving the water by electrolysis which allows its consumption to be monitored in real time, in parallel with the consumption of untreated water, on the same distribution network.

The various purposes of the invention are advantageously achieved by means of a water distribution and treatment system by electrolysis comprising in a case a hydraulic circuit comprising an inlet for connecting to a water supply source and an outlet for connecting to a water distribution device, said connection inlet and outlet being hydraulically linked together by an solenoid valve electrically connected to an electrical supply and control device, characterized in that it comprises a water electrolysis module comprising at least two electrodes, said electrolysis module being electrically connected to the power supply and control device and hydraulically connected to the connection inlets and outlet, the electrolysis module being positioned downstream of the solenoid valve and bypassed by the solenoid valve in standard operation.

There is no element between the electrodes, so no solid electrolyte. The empty configuration between the electrodes allows the water to circulate with a turbulent dynamic regime in order to ensure the renewal of the water molecules on the surface of the electrodes and thus optimize the action on these water molecules, and not on the salts that the water could contain as it is the case in the prior art.

When the electrolysis module is activated, all of the water flowing through the system passes between the electrodes, not just some of the water. The two electrodes are positioned opposite each other, and oriented in the flow direction of the water. The entire water flow passes through the electrolysis module, and thus the entire water flow passes through the space between the two electrodes. The amount of electrical charge delivered per unit volume of water is less than 0.05 Ah/L. Preferably, the amount of electrical charge is in the range of 0.005 Ah/L to 0.05 Ah/L. This amount of charge does not allow the production of ozone, and does not allow the water purification because it is not high enough. Moreover, this is not at all the objective of the invention, quite the contrary.

In a first embodiment, which may be termed a stand-alone system, the system of the invention is a stand-alone system comprising a water tank constituting the water supply source, adapted to be hydraulically connected to said connection inlet of the hydraulic circuit, the connection outlet of which is connected to or formed directly by an electrolyzed water distribution nozzle, preferably integrated in the case and forming a water distribution device. The water tank is advantageously integrated releasably or added to the case, as for example on commercially available machines for preparing various hot drinks such as coffee or tea. The system of the invention thus has a compact, mobile format, independent of a running water source.

Alternatively, in particular for professional applications or those suitable for higher consumption levels, the water supply source is a connection to the common hydraulic network of running water of a building, and the distribution device is a tap or distribution fountain, for example.

In all cases, there is no need for an integrated pumping element, as the system of the invention is connected to the existing network.

According to a preferred embodiment, at least one electrode is a boron-doped diamond electrode; its boron concentration being between 200 ppm (3×10¹⁹ B atoms/cm³) and 1500 ppm (2×10²⁰ B atoms/cm³). Unlike the prior art where the amount of electric charge is high, which causes the diamond electrode to polarize to improve its performance against depollution, sometimes even with the addition of a solid electrolyte, here the amount of electric charge is low, and the diamond electrode does not polarize, and its action is focused only on the structure of the water molecules, which is modified, improved.

According to a preferred embodiment, the power supply and control device is configured to electrically power the electrolysis module only under a control action of a user by actuation means.

Such a configuration has the advantage of allowing a selective activation of the electrolysis module, so that the user can choose when to consume his electrolyzed water. If the electrolysis module is not actuated, the user can then obtain “normal” water from the distribution network, cold or hot, as in the classic use of a tap or a shower or any water supply.

According to a preferred embodiment, the actuation means of the electrolysis module comprise either: an electromechanical switch, an electro-optical or biometric switch, or an electromagnetic switch.

Advantageously, the system of the invention may comprise several electrolysis modules if necessary.

According to a preferred embodiment, one of said electrolysis module is removable and comprises hydraulic connection plugs at the inlet and outlet of the hydraulic circuit and at least one electrical connector for connecting to the power supply and control device.

According to a preferred embodiment, one of said electrolysis module is packaged in the form of a recyclable removable cartridge adapted to be manually inserted and removed without tools from said case. This provides an electrolysis module that is easy and quick for the user to connect, as with other conventional consumable systems (printers, hard drives, sediment or carbon filters, etc.)

According to a preferred embodiment, it comprises a distribution member, in particular a tap, hydraulically connected to the outlet of the hydraulic circuit and comprising a means for actuating the electrolysis module electrically connected to the control and supply device.

According to a preferred embodiment, the actuation means is a biometric fingerprint reader or a capacitive switch for example. Such an actuation means can be installed either directly on the case in the case of a stand-alone system, or directly at the point of distribution, such as a tap, in the case of a professional system.

According to a preferred embodiment, the power supply and control device is configured to electrolyze at most a certain volume of water per day. This ensures that the electrolysis module functions properly and lasts for a long time, and that the consumption is controlled without any health risks for the consumers or unauthorized commercial use.

According to a preferred embodiment, the power supply and control device comprises an electronic module comprising at least one printed circuit, a microprocessor and at least one memory as well as at least one wireless communication chip, WiFi card or mobile data.

In particular, it is possible to actuate the electrolysis module by simple wireless remote control using any known wireless communication protocol.

In a particularly advantageous way, the electronic control module comprises at least one neuronal network, one flow rate sensor upstream of the electrolysis module to actuate the production of electricity in the electrolysis module when the water passes through the circuit and at least one flow rate monitor at the outlet of the electrolysis module so as to measure the volumes of electrolyzed water consumed during a given period by one or more determined users, to transmit and record this information to a database to which the control module is connected and to analyze the consumption habits and to draw up automatic reports that can be consulted via the Internet network and/or a wireless application.

According to a preferred embodiment, the control module is configured to determine the wear of the electrodes of the electrolysis module based on the measured electrolyzed water consumption data and amount of current flowing between the electrodes.

According to a preferred embodiment, the system of the invention further comprises status light indicators of the electrolysis module, said indicators being connected to and controlled by the power supply and control device.

Finally, still advantageously, the system of the invention preferably further comprises a flow meter between the connection inlet and the electrolysis module, adapted to regulate the hydraulic flow rate at the inlet of the electrolysis module to a substantially constant value (between 0.5 and 5 L/minute).

According to the invention, the system comprises a protective case delimiting an internal volume inside which are arranged the solenoid valve, the electrical power supply and control device and the water electrolysis module, said case having two access orifices to the connection inlet and outlet for the hydraulic connection, said case being portable.

The Attached Drawings Illustrate the Invention:

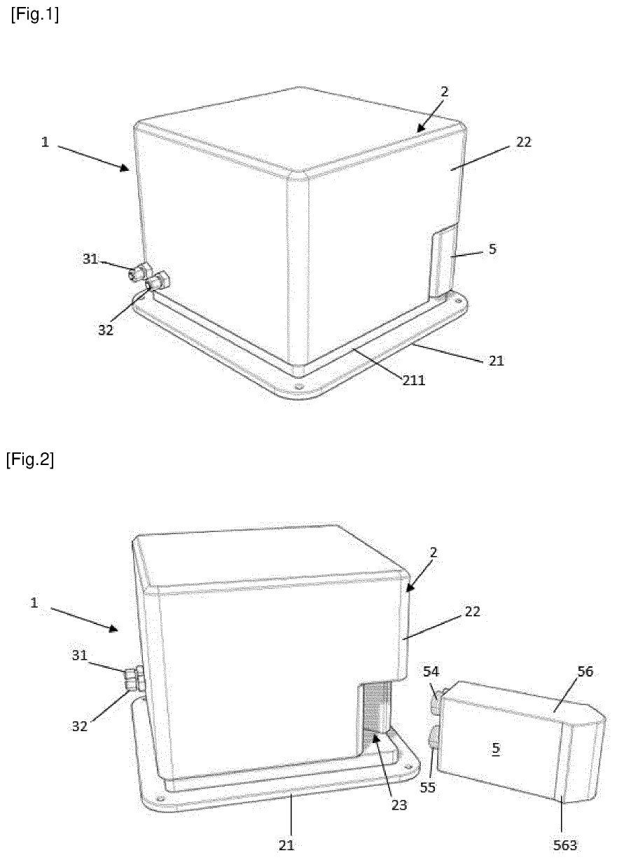

FIG. 1 shows a perspective view of a water distribution and treatment system according to the present invention in a preferred embodiment;

FIG. 2 shows a perspective view from a second angle of view of the water distribution and treatment system of FIG. 1 from which a removable electrolysis cell is removed;

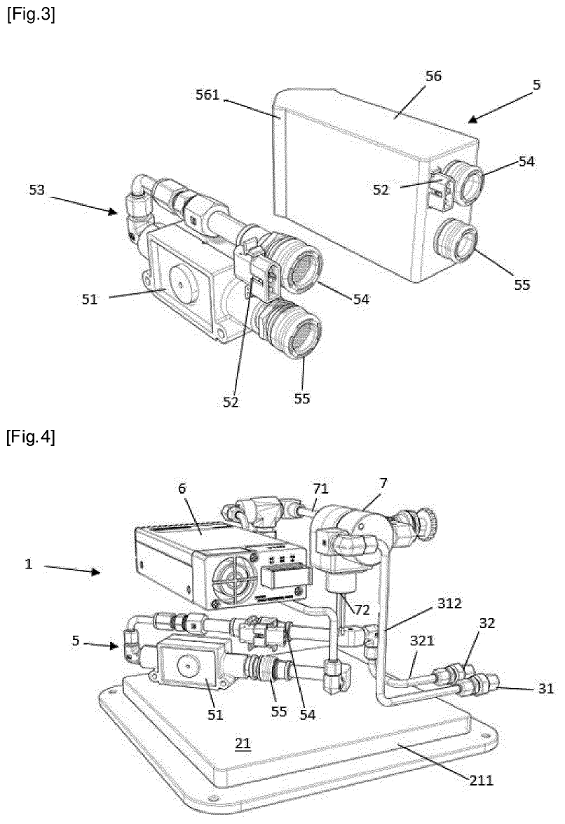

FIG. 3 shows a perspective view of the removable electrolysis cell of the water distribution and treatment system of the invention, respectively with and without an embellisher case,

FIG. 4 shows a perspective view of the water distribution and treatment system of FIG. 1 from a third angle after removal of its protective case and showing the internal operational structure of the system;

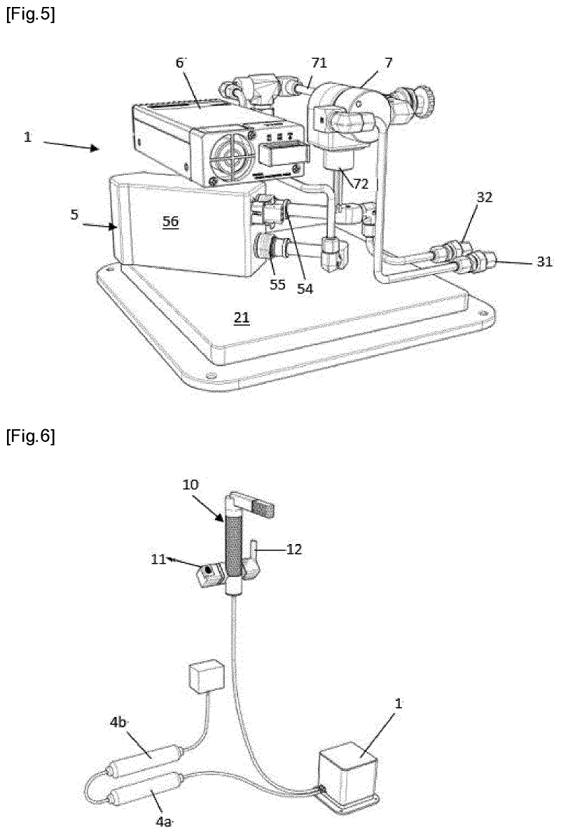

FIG. 5 shows a view similar to FIG. 4, but with the removable electrolysis cell comprising its embellisher case.

FIG. 6 represents the water distribution and treatment system of the invention connected at the inlet to a running water supply network and at the outlet to a connected distribution tap.

The present invention will be described in more detail and with the aid of a preferred embodiment shown in FIGS. 1 to 6, which in no way limits the invention to this embodiment alone.

A water distribution and treatment system 1 according to the present invention comprises firstly a protective case 2 comprising a pedestal 21 and a cap 22, adapted to releasably cover the pedestal 21. The pedestal and the cap 22 thus delimit an internal volume inside which are arranged the functional distribution and treatment members of the system of the invention as will be described hereafter with reference to FIGS. 2 to 5 in particular.

Advantageously, the pedestal 21 may comprise a peripheral edge shoulder 211 configured to provide a male form configured to fit into the cap 22, so as to hold the latter without tools on the pedestal once placed, the cap 22 having a cross-section, i.e. in the present example considered in a parallel horizontal plane. Where appropriate, a groove for shimming the lower edge of the cap 22 may be provided in the peripheral edge of the pedestal 21 to provide a tighter fit of the cap 22 on the pedestal 21.

The water distribution and treatment system 1 also comprises a hydraulic circuit 3 comprising an inlet 31 for connecting to a water supply source and an outlet 32 for connecting to a running water distribution network. In the example shown, these connection inlets 31 and outlets 32 are arranged next to each other, but this positioning is purely arbitrary and other configurations are possible.

Preferably, as shown in FIG. 6, a carbon filter 4a is installed on the upstream conduit at the inlet 31 into the case 2 to capture the residual chlorine contained in the running water for supplying the system. Where appropriate, a second filter 4b with a pore size of 1 to 10 microns is also integrated upstream of the inlet 31 in order to remove the larger solid parts that may be contained in the water entering the system 1.

In this example, the distribution system 1 is intended for a connection to the running water network of a building on the one hand, for a distribution via a remote tap as shown in FIG. 6. However, the system of the invention 1 can also be offered in a stand-alone form, for private individuals, with a water tank connected to the connection inlet 31 and a distribution tap connected to the connection outlet 32, both of which are integrated or added to the case 2, making the system 1 independent of any external water supply and requiring only an electrical power supply, either wired or battery powered.

The connection inlet 31 communicates via a conduit 312 to an inlet of an electrolysis module 5, shown in detail in FIG. 3. A three-way solenoid valve 7, for example with a solenoid, is arranged in the conduit 312, the two outlet ways 71, 72 of which are connected to the electrolysis module 5 and the connection outlet 32 respectively. As will be explained below, the distribution and treatment system 1 of the invention allows to distribute an electrolyzed or non-electrolyzed water as desired, depending on a control action by a user. The electrolysis module 5 and the solenoid valve 7 are electrically connected to a power supply and control device 6, which receives a user control signal to actuate or not the solenoid valve 7 and the electrolysis module 5. By default, the solenoid valve 7 switches from the connection inlet 31 to the connection outlet 32 without passing through the electrolysis module 5. On command from a user by any suitable means the solenoid valve 7 and the electrolysis module are activated simultaneously and the solenoid valve 7 diverts the inlet hydraulic flow to the electrolysis module 5 which is connected at the outlet by a conduit 321 to the connection outlet 32, which is hydraulically connectable to a consumer distribution device such as a tap 10 as shown in FIG. 6.

The electrolysis module 5 is positioned downstream of the solenoid valve 7 and is bypassed by the solenoid valve 7 in standard operation. The solenoid valve 7 therefore corresponds to a bypass. The electrolysis module 5 is only operated on the user's instruction.

The protective case 2 thus delimits an internal volume inside which the solenoid valve 7, the electrical power supply and control device 6 and the water electrolysis module 5 are arranged. Said case comprises two access orifices to the connection inlets and outlets 31, 32 for the hydraulic connection, as clearly seen in FIG. 1. This case is compact and nomadic, i.e. it is easily transportable, and can be connected to any existing network, or to any machine requiring water as inlet.

In addition, a flow meter is also preferably arranged on the conduit 312 prior to the inlet of the electrolysis module 5 to measure and regulate the hydraulic flow rate at the inlet of the electrolysis module 5 to a substantially constant value. This flow rate value may be set once and for all at the factory before the system of the invention is installed on site, or it may be regulated in-situ electronically by the electrical power supply and control device 6 to which the flow meter is connected, such as the solenoid valve 7 and the electrolysis module 5, in order to supply and control the assembly.

As can be seen from FIG. 2, the electrolysis module 5 is removable from the case 2. Advantageously, it is in the form of a cartridge that can be manually connected in a housing 23 provided for this purpose in the case 2, more particularly in the cap 22 thereof. This electrolysis module 5 consists very simply of at least two electrodes, including at least one boron-doped diamond electrode arranged in an electrolysis cell 51 and electrically connected by an industrial connector 52 to the power supply and control module 6. The boron-doped diamond electrode is attached to a substrate which may be silicon, niobium, tantalum, tungsten or a mixture thereof, silicon being the preferred substrate.

When the electrolysis module is activated, all of the water flowing through the system passes between the electrodes, not just some of the water. The two electrodes are positioned opposite each other, and oriented in the flow direction of the water. In this case, each electrode consists of a plate of 2.5 cm high and 5 cm long, thus having a surface of 12.5 cm². These two plates are separated by about 1 mm. The water therefore passes completely through this 1 mm gap between the plates. The entire water flow passes through the electrolysis module, and thus the entire water flow passes through the space between the two electrodes. The amount of electrical charge delivered per unit volume of water is less than 0.05 Ah/L. Preferably, the amount of electrical charge is in the range of 0.005 Ah/L to 0.05 Ah/L.

According to a preferred embodiment, the boron concentration of the electrode for an optimal performance of the electrolysis cell 51 is between 200 ppm (3×10¹⁹ B atoms/cm³) and 1500 ppm (2×10²⁰ B atoms/cm³).

Without being bound by the theory, the boron-doped diamond electrodes (known as BDD) on a silicon substrate allow to achieve high electrolysis potentials, superior to the platinum electrodes conventionally used for the electrolysis of the water, in particular in terms of durability and potentiation of the water

The selected boron concentrations provide an optimum to obtain a good electrolyzed water while guaranteeing a good service life of the electrode (threatened if the boron concentration increases) and a good ohmic conductivity (reduced if the boron concentration decreases).

According to a preferred embodiment, the control module 6 is configured to determine the electrode wear of the electrolysis module 5 according to the measured data of consumption of electrolyzed water and amount of current flowing between the electrodes as explained below.

As can be seen from FIG. 3, the electrolysis cell 51 is integrated in a bent circuit section 53, the ends 54, 55 of which are aligned and parallel to each other. These ends 54, 55 are each equipped with a hydraulic quick coupling adapted to operate a secure connection/disconnection with complementary connectors to the inlet/outlet connection conduits of the distribution system by simply pushing/withdrawing the electrolysis module into the insertion housing 23 provided for this purpose in the cap 22 of the case 2.

In order to ensure an optimum protection of the electrolysis cell, the latter is fitted in a casing 56, the shape of which blends in perfectly with the lines of the case 2 and the cap 22 in order to provide a satisfactory appearance. It will be noted that the hydraulic quick couplings 54, 55 and electrical connector 52 of the electrolysis module 5 extend in a projecting manner at a first longitudinal end of the casing 56 in order to be able to make the connection of the module 5 when it is inserted in the housing. In addition, the second longitudinal end of the casing 56 is advantageously shaped to have manual gripping edges 561 to facilitate the removal and the insertion of the electrolysis module 4.

As can be seen from the figures, the housing 23 for inserting the electrolysis module 5 is arranged in a corner of the cap 22, so as to guide the module 5 when it is inserted substantially along a diagonal of the case 2, at 45° with respect to two consecutive sides of the pedestal 21 and the cap 22. This specific orientation is advantageously chosen not for its particular aesthetic rendering but to provide a better compactness to the treatment and distribution system 1 of the invention, by using the largest dimension of the case 2 to house the electrolysis module without unnecessary loss of space inside the case 2.

The electrolysis module 5 is not switched on instantaneously when the electrolysis module 4 is inserted into the case 2; on the contrary, the power supply and control device 6 is advantageously configured to supply electrical power to the electrolysis module 5 only under a control action of a user by means of actuation means.

Such a configuration has the advantage of allowing selective activation of the electrolysis module 5, so that the user can choose the moment of consumption of his electrolyzed water. If the electrolysis module 5 is not actuated, then the user can obtain a “normal” water from the distribution network at the tap, with the solenoid valve 7 simply closing the default distribution circuit to the connection outlet 32 without passing through the electrolysis cell 51 as previously discussed.

The power supply and control device 6 comprises an electronic control module comprising at least one printed circuit, a microprocessor and at least one memory as well as at least one wireless communication chip, said wireless communication chip forming, if necessary, but not necessarily, a means for actuating the electrolysis module 5 by transmission of a suitable electromagnetic signal from a suitable remote control/switch. The power supply and control device 6 is preferably equipped with wireless connection and communication means (Wifi, Bluetooth, 4G/5G cellular connection or other) allowing not only the transmission of a control and actuation signal of the electrolysis module 5 but also remote updates of the operating system embedded in the memory of the control device, of the microprocessor operating drivers etc., as well as the transmission of operating and consumption data of electrolyzed water to a database, which allows an analysis of the quantities of water consumed by each member of the family or of the workplace, the hours of consumption, the frequency of consumption etc.

Before the first implementation of the distribution system of the invention, each user thus creates a consumer profile in a database accessible online on the Internet network and made available by the supplier of the distribution and treatment system 1 in particular. Once a user has been registered, he or she must register one or more fingerprints in his user profile, as is done in many existing applications. Once the registration has been performed, it is then possible to use the distribution and treatment system 1 to obtain an electrolyzed water or not.

Optionally, a consumer data analysis service may be associated with the distribution system of the invention, in particular by means of an artificial intelligence and an application and/or an online user account. A simple device for learning and compiling consumption data may comprise one or more neuronal networks integrated with the electronic control module. Such neuronal networks allow in particular to automatically analyze the personalized consumption behavior of the users. This data can then be compiled and advice and analysis transmitted via the application and the user account.

The remote actuation means of the electrolysis module 5 may comprise, in particular, the following options: an electromechanical switch, an electro-optical or biometric switch, an electromagnetic switch such as a wireless control signal (by infrared or radio waves, or even a Wifi or Bluetooth protocol for example).

In the example shown in FIG. 6, the tap 10 comprises, for example, a fingerprint reader 11 on which a user must place a finger in order to initiate the operation of the electrolysis module 5. He then simply opens the tap 10 by means of the conventional lever 12 thereof in order to draw an electrolyzed water from the tap.

According to the invention, the power supply and control device 1 is also configured to electrolyze at most a given volume of water V per day, regardless of the number of potential users. This ensures that the electrolysis module 5 functions properly and lasts for a long time, and that a consumption is controlled without any health risk for the consumers or unauthorized commercial use.

Finally, the system 1 of the invention further comprises status light indicators of the electrolysis module 5, said indicators being connected to and controlled by the power supply and control device 6.

If a single electrolysis module 5 is sufficient for a use in a private home supply network (apartment, house), the treatment system of the invention can also be declined in a professional version for water fountains or treatment systems on hydraulic network of company. In these configurations, the case 2 may comprise a plurality of housings intended to receive a plurality of identical electrolysis modules 5, which may be connected, used and replaced independently of each other. This allows the volume of water treated per day to be maximized on a treatment and distribution system 1.

One of the great advantages of the system 1 of the invention lies in the capacity offered for the first time to measure and analyze in real time the water consumption of each person in a household or a place and to derive from it, in an automated manner, by an automatic learning method and an associated artificial intelligence, profiles of consumption and condition of the persons, these profiles can be completed, if necessary, by any other useful health information that users can themselves feed to the artificial intelligence by means of a telephone connected to the Internet and an application, for example, or from a computer connected to the Internet network.

Thus, each consumer/user will be able to evaluate his or her water stress or surplus, the quantity of electrolyzed water according to his or her needs/recommendations according to certain wellness or health objectives.

1. A water distribution and treatment system (1) comprising a hydraulic circuit comprising an inlet (31) for connecting to a water supply source and an outlet (32) for connecting to a water distribution device, said connection inlet and outlet being linked together by an solenoid valve (7) electrically connected to an electrical supply and control device (6), characterized in that it comprises a water electrolysis module (5) comprising at least two electrodes, said electrolysis module (5) being electrically connected to the power supply and control device (6) and hydraulically connected to the connection inlets and outlet (31, 32), the electrolysis module (5) being positioned downstream of the solenoid valve (7) and bypassed by the solenoid valve (7) in standard operation.

2. The system according to claim 1, characterized in that at least one of the electrodes is a boron-doped diamond electrode, the boron concentration being between 200 ppm (3×10¹⁹ B atoms/cm³) and 1500 ppm (2×10²⁰ B atoms/cm³)

3. The system according to any of claim 1 or 2, characterized in that the power supply and control device (6) is configured to electrically power the electrolysis module (5) only under a control action of a user by actuation means.

4. The system according to one of the preceding claims, characterized in that in the electrolysis module (5) the amount of electrical charge delivered per unit volume of water is less than 0.05 Ah/L.

5. The system according to one of the preceding claims, characterized in that it comprises a plurality of electrolysis modules (5).

6. The system according to one of claims 1 to 5, characterized in that one of said electrolysis module (5) is removable and comprises hydraulic connection plugs (54, 55) at the inlet and outlet of the hydraulic circuit (31, 32) and at least one electrical connector (52) for connecting to the power supply and control device (6).

7. The system according to any one of claims 1 to 6, characterized in that one of said electrolysis module (5) is packaged in the form of a recyclable removable cartridge adapted to be manually inserted and removed without tools from said case (2).

8. The system according to one of claims 3 to 7, characterized in that it comprises a distribution member (10), in particular a tap, hydraulically connected to the outlet (32) of the hydraulic circuit and comprising a means (11) for actuating the electrolysis module (5) electrically connected to the control and supply device (6).

9. The system according to claim 8, characterized in that the actuation means is a biometric fingerprint reader (11).

10. The system according to one of the preceding claims, characterized in that the power supply and control device (6) is configured to electrolyze at most a certain volume of water (V) per day.

11. The system according to one of claims 3 to 7, characterized in that the power supply and control device (6) comprises an electronic control module comprising at least one printed circuit, a microprocessor and at least one memory as well as at least one wireless communication chip.

12. The system according to claim 11, characterized in that the electronic control module (6) comprises at least one neuronal network and at least one flow rate sensor at the outlet of the electrolysis module (5) so as to measure the volumes of electrolyzed water consumed during a given period by one or more determined users, to transmit and record this information to a database to which the control module is connected and to analyze the consumption habits and to draw up automatic reports that can be consulted via the Internet network and/or a wireless application.

13. The system according to claim 12, characterized in that the control module (6) is configured to determine the wear of the electrodes of the electrolysis module (5) based on the measured electrolyzed water consumption data.

14. The system according to any of the preceding claims, further comprising status light indicators of the electrolysis module (5), said indicators being connected to and controlled by the power supply and control device (6).

15. The system according to any of the preceding claims, characterized in that it further comprises a flow meter or a flow sensor between the connection inlet (31) and the electrolysis module (5), adapted to regulate the hydraulic flow rate at the inlet of the electrolysis module to a substantially constant value.

16. The system according to one of the preceding claims, characterized in that it comprises a protective case (2) delimiting an internal volume inside which are arranged the solenoid valve (7), the electrical power supply and control device (6) and the water electrolysis module (5), said case having two access orifices to the connection inlet and outlet (31, 32) for the hydraulic connection, said case being portable.
